(19) United States
(12) Patent Application Publication
(10) Pub. No.: US 2003/0084164 A1
(43) Pub. Date: May 1, 2003

(54) Multi-threaded server accept system and method

(76) Inventor: John Joseph Mazzitelli, Sicklerville, NJ (US)

Correspondence Address: HEWLETT-PACKARD COMPANY, Intellectual Property Administration, P.O. Box 272400, Fort Collins, CO, 80527-2400, US

(21) Appl. No.: 10/057,135

(22) Filed: Oct. 29, 2001

(51) Int. Cl. G06F 15/16

(52) U.S. Cl. 709/227; 709/330

(57) ABSTRACT

A multi-threaded server accept system and method creates a socket accept thread by a control thread of a server process, receives a service request from a client by the socket accept thread, and transfers the request to a data structure. The system and method further comprise retrieving the request by the control thread from the data structure, transferring the request to a client thread, by the control thread, to process request data associated with the request, and processing the request data by the client thread.

### TECHNICAL FIELD OF THE INVENTION

The present invention relates in general to telecommunications and, more particularly, to a multi-threaded server accept system and method.

### BACKGROUND OF THE INVENTION

Developments in technology have enabled global communications over a variety of networks such as the Internet. Communication over these networks has dramatically gained favor with improvements in bandwidths, processing speed, and server and other computing platform technologies.

Many entities and individuals communicate over networks in a client-server fashion, where a client requests service from a server, such as a web server that processes data for the client. A client program typically connects to a program residing on the server via the network through a software mechanism, usually a socket or port, that works similarly to a telephone connection where the server waits for, and receives, calls from clients. A server program creates a server socket that listens for clients that want to make a connection. For example, a server at a search engine site will listen for clients who want to make a connection, and then for those clients' connection requests. After a client sends a request to that site, the server and client perform a number of functions to establish the connection and to transfer data back and forth during the connection time.

For example, while the server is busy processing a client's request, additional connection requests that come in from other clients will be stored by the server's operating system in a backlog queue where they will remain until the server can accept those new connection requests, which in turn removes them from the operating system backlog queue. Unfortunately, an operating system backlog queue can only store a finite number of connection requests. If an operating system is overloaded with a large number of connection requests from clients and/or the server spends too much time processing a request before it can accept additional incoming connection requests, the operating system may not be able to handle all of the requests before the backlog queue fills up to capacity. In this situation, any additional clients trying to access the server will typically be refused the connection. Moreover, the server is prevented from being efficiently used, and the server's operating system may not be able to process a large number of incoming connection requests during long connection times with other clients. Server efficiency is paramount, due to the uncertain nature of connection times. For example, a connection time required by the server to process the request varies widely from several milliseconds to several minutes, depending on the application. To illustrate, a simple refresh command may require only a few milliseconds to complete, whereas a database query may last for several minutes.

One attempted to address the concerns by having the server create a client thread for each request that it receives from a client. The server then passes off the client socket to the client thread after accepting the socket connection from the client, which allows the client thread to continue the data processing for the current client, while the server may accept other incoming client connection requests. Unfortunately, during the processing performed by the server, the server operating system may still fail to process other clients requests, resulting in denied requests and inefficient use of server processing capability.

### SUMMARY OF THE INVENTION

One illustrative embodiment of the invention is a multi-threaded server accept method that comprises creating a socket accept thread by a control thread of a server process, receiving a service request from a client by the socket accept thread, and transferring the request to a data structure. The method further comprises retrieving the request by the control thread from the data structure, transferring the request to a client thread, by the control thread, to process request data associated with the request, and processing the request data by the client thread.

Another illustrative embodiment of the invention is a multi-threaded server accept system, comprising a server process residing on the server. The process is operable to create a socket accept thread by a control thread of a server process residing on the server, receive the request from a client by the socket accept thread, and transfer the request to a data structure. The server process is also operable to retrieve the request by the control thread from the data structure, transfer the request to a client thread, by the control thread, to process request data associated with the request, and process the request data by the client thread.

Yet another illustrative embodiment of the invention is a multi-threaded server accept application, comprising an application software residing on a computer-readable medium. The application software is operable to create a socket accept thread by a control thread of a server process residing on the server, receive a service request from a client by the socket accept thread, and transfer the request to a data structure. The application software is also operable to retrieve the request by the control thread from the data structure, transfer the request to a client thread, by the control thread, to process request data associated with the request, and process the request data by the client thread.

### BRIEF DESCRIPTION OF THE DRAWINGS

FIG. 1 is an example of a block diagram of a multi-threaded server socket accept system utilizing teachings of the present invention,

FIGS. 2A, 2B, and 2C are examples of a method that may be used in a multi-threaded server socket accept system utilizing the teachings of the present invention, specifically

FIG. 2A is an example of a method that may be used to wait for a client connection utilizing the teachings of the present invention,

FIG. 2B is an example of a method that may be used by a control thread of a server process to process a request utilizing the teachings of the present invention, and

FIG. 2C is an example of a method that may be used by a client thread to process request data utilizing the teachings of the present invention.

### DETAILED DESCRIPTION OF THE DRAWINGS

From the foregoing, it may be appreciated that a need has arisen for enabling clients to establish and process connections with servers over a network. In accordance with the present invention, a multi-threaded server accept system and method are provided that substantially eliminate or reduce disadvantages and problems of conventional systems.

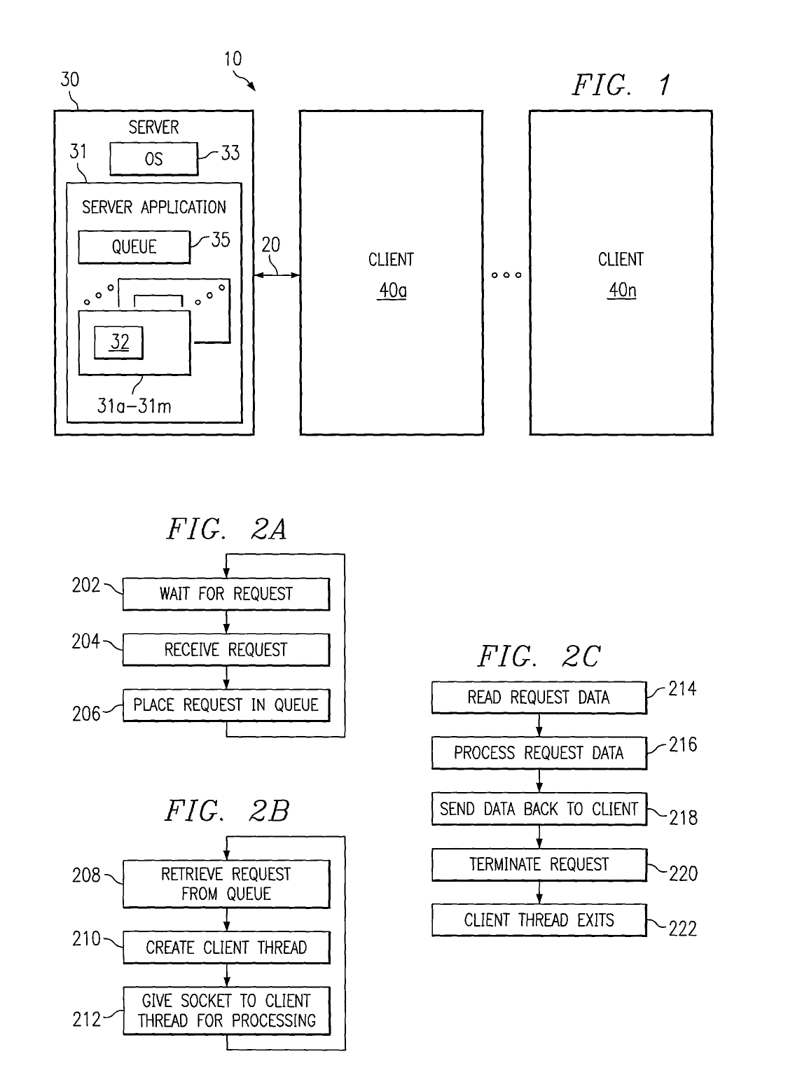

FIG. 1 is a block diagram of an example of a multi-threaded server socket accept system utilizing teachings of the present invention. In the embodiment illustrated in FIG. 1, system 10 comprises a server 30 that is operable to receive requests from clients 40a-40n over at least one communication link 20. Generally, the present invention provides for accepting requests from clients 40a-40n by a socket accept thread spawned by a control thread of server application, or process, 31 and processing the requests by using the control thread together with any client threads that may be spawned by the control thread. The present invention contemplates the socket accept thread 31b executing independently of control thread 31a. The invention also contemplates socket accept thread 31b executing either in serial or virtually simultaneously with, control thread 31a. As one example, socket accept thread 31b may transfer requests to the data structure before control thread 31a may retrieve the request from the data structure. As another example, socket accept thread 31b may transfer requests to the data structure virtually simultaneously as control thread 31a retrieves the request from the data structure. One method for performing virtual simultaneous yet independent thread processing includes utilizing a single processor that multiplexes the processes, which may provide the appearance to a user that the processes are being performed simultaneously. Another method for performing virtual simultaneous yet independent thread processing includes utilizing parallel processing. Therefore, in these latter scenarios, in the time the control thread 31a can handle one request from the queue, socket accept thread 31b may accept multiple requests and place them all on the queue. This advantage allows the socket accept thread 31b to accept many more connections than a control thread would normally have been able to accept on its own as with conventional systems, and thus improper system effectiveness being sent to clients by connection refused errors from the operating system.

Server 30 may be a general or a specific purpose computer and includes an operating system OS 33. For example, server 30 may be one of a variety of servers including, but not limited to, a web server, database server, or universal business server, and may be a task-specific or custom-design processing system that may be specifically configured to interface with various devices and to perform in accordance with the methods described herein. Server 30 may also be a personal computer (PC), which are well-known and are readily commercially available. OS 33 includes an internal backlog queue (not explicitly shown) that is not directly accessible by any server application 31. Rather, an internal backlog queue is stored inside of the memory allocated to OS 33 and is only accessible to OS 33.

Server 30 may be used to execute one or more server applications 31, and threads 31a-3m spawned by server applications 31, that include logic, or application software, that is operatively associated with server 30 and that utilizes a communications technology such as sockets. A socket 32, or port, provides an endpoint for computers or processing platforms to communicate with each other. In a particular embodiment, a socket may have a dedicated value (e.g., Internet standards require web servers to communicate using port 80, whereas other servers such as database servers may be assigned ports other than port 80). A socket works with an OS as an abstraction to provide the capability for applications 31 to automatically access communications protocols such as Transport Control Protocol/Internet Protocol (TCP/IP). A socket creates a logical direct link between server 30 and an entry point on the requesting client, such as a browser.

Clients 40a-40n may be any clients operable to request service from server 30 such as a workstation or wireless device and may in fact be another server. For example and in a particular implementation, the present invention contemplates a web server as one of clients 40a-40n where it submits a request to a server 30 that is a database server. Server 30 may be coupled to clients 40a-40n over one of a variety of networks as represented by communication link 20, including global communication networks such as the Internet, local area networks, wide area networks, the public switched telephone network (PSTN), and wireless networks. Communication link 20 may be directly or indirectly coupled to these networks. These networks may use communications protocols such as, but not limited to, HyperText Transfer Protocol (HTTP), TCP/IP, and wireless application protocol (WAP).

Server 30 operates in conjunction with applications 31 and threads 31a-31m to process requests from clients 40a-40n. For example, in the embodiment illustrated in FIG. 1, server 30 may access and/or include programs or software routines of applications 31 and/or 31a-31m, depending on the particular application. Many methods for implementing a software architecture may be used and include, but are not limited to, object-oriented methods, and software languages including, but not limited to, C and JAVA. Server 30 may also be connected to, or include, a memory system, such as a cache or random access memory (not explicitly shown), suitable for storing all or a portion of these programs or routines and/or temporarily storing data during various processes performed by server 30. Memory may be used, among other things, to support real-time analysis and/or processing of data.

Server 30 also includes a queue 35. In a particular embodiment, queue 35 is preferably a first in, first out (FIFO) queue that is resident in memory allocated to server application 31 and directly accessible by server application 31 and multiple threads 31a-31m. The present invention contemplates the use of various data structures such as queue 35 including, but not limited to, tables or other storage media that allow quick and efficient access to data stored therein by threads 31a-31m in accordance with the invention. Moreover, the present invention contemplates the position of data structures such as queue 35 in a variety of implementations including, but not limited to, memory not specifically allocated to server application 31 and multiple threads 31a-31m. Queue 35 may be a different queue from an internal backlog queue of OS 33, where processing speed dictates.

Server application 31 may be used to spawn multiple threads 31a-31m to process requests from clients 40a-40n. Although multiple threads 31a-31m are illustrated in FIG. 1, the number of multiple threads 31a-31m is only limited by the implementation. For example, parallel processing techniques may increase the number of multiple threads 31a-31m that may be used to process requests by server 30. Server application 31 may be described as being a multi-threaded process that has multiple threads that each independently execute, whether on the same server 30 or other platform, and whether using a single or multiple processors residing on server 30. These individual processes within server application 31 are operable to collectively process each request from clients 40a-40n.

Although the present invention contemplates a variety of methods for processing requests from clients 40a-40n, one method for processing requests is described in further detail in conjunction with FIGS. 2A-2C. For illustrative purposes and as but one example, FIGS. 2A, 2B, and 2C are described using socket technology and object-oriented methodology that utilizes JAVA and software classes, methods and objects. In the C programming language, there are analogous programming methods such as accept( ) and socket( ) which are used to create socket file descriptors and wait for client connections on those sockets.

FIGS. 2A, 2B, and 2C are examples of a method that may be used in a multi-threaded server socket accept system utilizing the teachings of the present invention. Although the invention contemplates numerous methods for implementing the method as is discussed below, it may be illustrative, before discussing the specific steps referred to in FIGS. 2A, 2B, and 2C, to discuss existing systems and methods used to process requests from clients 40a-40n.

These systems utilized a single server application 31 that waited for clients 40a-40n to connect with a client socket, processed the socket until the transaction was completed, and then closed the socket. An application programming interface (API) used in JAVA is called java.net.ServerSocket to create a server socket. In these systems, server application 31 would call a java.net.ServerSocket.accept( ) method, or accept( ), and would wait for a client to request a processing connection, thus forcing server application 31 to pause and wait for the connection. Once a client attempts such a connection, the accept( ) method would wake up and return a java.net.Socket object, or client socket, that is created upon the return of the accept( ) method to a server application. Upon accepting the connection, the server application would use the client socket to communicate with the client to process the client's request. Upon completion, server application would then close the socket connection and would call accept( ) method to wait for another client connection. Later systems included a client thread that was used to process the request, and to close the socket. Unfortunately, such conventional systems did not reduce the time required by the server application to wait for, and complete, the connection process of obtaining the client socket.

To facilitate discussion of the present invention, the steps of reading client data from client socket 32, processing the request data, and sending data back to the client via the socket may be denoted “processing request data” below. Furthermore, the steps of retrieving the request and ensuring that the request is processed may be denoted “processing the request.” Various embodiments may utilize fewer or more steps, and the method may be performed using a number of different implementations, depending on the application. Generally, the method according to the invention provides a way for server 30 to efficiently and advantageously process requests from clients 40a-40n so that denials of requests are eliminated or reduced. In a particular embodiment, server 30 may utilize a software architecture that includes server application 31, and that may be logically composed of several classes and interfaces. These classes may operate in a distributed environment and communicate with each other using distributed communications methods, and may include a distributed component architecture such as Common Object Request Broker Architecture (CORBA), JAVA Remote Method Invocation (RMI), and ENTERPRISE JAVABEANS.

FIG. 2A is an example of a method that may be used to wait for a client connection utilizing the teachings of the present invention. FIG. 2A includes steps 202-206 that establish the client connection. In step 202, server 30 waits for a request from a client 40a-40n. As discussed above and in a particular embodiment, socket accept thread 31b is spawned by controller thread 31a of server application 31. Then, socket accept thread 31b calls accept( ) and waits for a client socket 32 to establish the connection. In step 204, the method receives the request and, in a particular embodiment, the accept( ) method wakes up and returns a java.net.Socket object, client socket 32, to server application 31. The method proceeds to step 206, where server 30 places received socket 32 in queue 35. Although the method contemplates a variety of implementations for queues that may be used, in a particular embodiment, queue 35 may be a first-in, first-out (FIFO) queue. From step 206, the method returns to step 202 to wait for a next request from clients 40a-40n and continues to loop through the method. The request proceeds to control thread 31a and a subsequently spawned child thread for further processing, as discussed in further detail in conjunction with FIGS. 2B and 2C.

FIG. 2B is an example of a method that may be used by a control thread 31a of server application 31 to process a request utilizing the teachings of the present invention. FIG. 2B includes steps 208-212 to process the request. In step 208, control thread 31a of server application 31, retrieves the received socket from queue 35. This step may be performed independently and virtually simultaneously with step 206. For example, in step 210, control thread 31a creates client thread 31c. In step 212, server 30 transfers the received socket to client thread 31c, which processes the request. From step 212, the method returns to step 208 to continue to retrieve the next request from queue 35. In a particular embodiment, control thread 31a may thus spawn client threads 31c-31m as desired. The present invention contemplates the use of a number of methods to create these client threads. For example, and not by limitation, some server implementations may utilize a thread pool. In this scenario, server 30 may initialize or create a set of client threads 31c-31m and reuse them as needed.

FIG. 2C is an example of a method that may be used by a second thread to process request data utilizing the teachings of the present invention. FIG. 2C includes steps 214-222 that processes request data. In step 214, client thread 31c reads client data from the client socket. This data may be, for example, a request for a specific HTML page or database query parameters. In step 216, client thread 31c processes the request data. As one example, client thread 31c may read an HTML file from disk to be sent back to client that requested it. In step 218, client thread 31c sends data back to the requesting client via socket 32. In step 220, client thread 31c terminates the request. As one example, client thread 31c closes the client socket via the close( ) method. In step 222, client thread 31c automatically exits.

A plurality of threads 31a-31m may be created to process requests by server 30 as needed. For example, socket accept thread 31b may continue to step 202 to wait for a second request after transferring the request to queue 35, and to receive the second request. Socket accept thread 31b will then transfer the second request to queue 35, in accordance with a method such as the one illustrated in FIG. 2A. The control thread 31a then retrieves the second request, and creates a second client thread 31d to process second request data associated with the second request, in accordance with a method such as the one illustrated in FIG. 2B. The control thread 31a then transfers the second request to the second client thread 31d to process the second request data. The second client thread 31d then processes the second request data in accordance with a method such as the one illustrated in FIG. 2C.

The present invention contemplates a virtually limitless number of requests that may be virtually simultaneously processed by server 30, depending on the implementation. For example, the number of requests that may be virtually simultaneously processed by server 30 may be increased by using parallel processing on server 30 with a plurality of processors, each using a server application 31 operable to perform the functions in accordance with the present invention.

Embodiments of the invention may provide a multi-threaded accept algorithm that uses an additional queue other than an internal operating system (OS) queue. In a particular embodiment, a separate socket accept thread may be implemented efficiently using software code, and can wait for client requests by calling a JAVA accept( ) method, and queue the requests, or accepted sockets, in a queue that is separate from a standard internal queue used by the server's operating system (OS). This allows the server to process requests separate from accepting and queuing them. Moreover, these embodiments may reduce or eliminate conditions that arise due to backlogged internal queues, which ultimately result in denied requests. Moreover, embodiments of the invention may provide the technical advantage of eliminating a dependency on the size of any internal operating system buffers that may be used to queue up client requests. Furthermore, embodiments of the invention may also accept connections from more clients at a faster pace than may be accepted with the use of conventional systems. This, in turn, allows a server to process more client requests than may be processed by conventional systems. Moreover, under a heavy load, or when a large number of clients make virtually simultaneous requests to a server, embodiments of the invention may provide the advantage of successfully servicing clients, whereas with the use of conventional systems, these requests would likely be denied.

What is claimed is:

1. A multi-threaded server accept method, comprising:
creating a socket accept thread by a control thread of a server process;
receiving a service request from a client by the socket accept thread;
transferring the request to a data structure; and
retrieving the request, by the control thread, from the data structure;
transferring the request to a client thread, by the control thread, to process request data associated with the request; and
processing the request data by the client thread.

2. The method of claim 1, wherein the data structure comprises a queue.

3. The method of claim 1, wherein the data structure comprises a FIFO queue.

4. The method of claim 1, further comprising waiting for service requests by performing an accept ( ) call.

5. The method of claim 1, wherein receiving the request comprises receiving a client socket object.

6. The method of claim 1, further comprising waiting for the service request from the client by the socket accept thread.

7. The method of claim 1, further comprising creating the client thread to process the request data.

8. The method of claim 1, further comprising:
receiving a second request by the socket accept thread from the client;
transferring the second request to the data structure;
retrieving the second request by the control thread;
transferring the second request to a second client thread to process second request data; and
processing the second request data by the second client thread.

9. The method of claim 8, further comprising creating the second client thread to process the second request data.

10. The method of claim 1, wherein the socket accept thread and the control thread are executed on a single processor.

11. The method of claim 1, wherein the steps of transferring the request to the data structure and retrieving the request from the data structure are serially performed.

12. A multi-thread server accept system, comprising:
a server process residing on a server and operable to
create a socket accept thread by a control thread of a server process residing on the server;
receive a service request from a client by the socket accept thread;
transfer the request to a data structure;
retrieve the request, by the control thread, from the data structure;
transfer the request to a client thread, by the control thread, to process request data associated with the request; and
process the request data by the client thread.

13. The system of claim 12, wherein the data structure comprises a queue.

14. The system of claim 12, wherein the data structure comprises a FIFO queue.

15. The system of claim 12, wherein the socket accept thread is operable to wait for service requests by performing an accept( ) call.

16. The system of claim 12, wherein the socket accept thread is operable to receive the request by receiving a client socket object from the client.

17. The system of claim 12, wherein the server process is further operable to create the client thread to process the request data.

18. The system of claim 12, wherein the server process is further operable to:
receive a second request from the client by the socket accept thread after transferring the request to the data structure;
transfer the second request to the data structure;
retrieve the second request by the control thread;
transfer the second request to a second client thread to process the second request data; and
process the second request data by the second client thread.

19. The system of claim 12, wherein the server process is further operable to create the second client thread to process the second request data.

20. The system of claim 12, wherein the socket accept thread and the control thread are executed on a single processor.

21. The system of claim 12, wherein the server process is further operable to serially perform the steps of transferring the request to the data structure and retrieving the request from the data structure.

22. A multi-threaded server accept application, comprising
an application software residing on a computer-readable medium and operable to:
create a socket accept thread by a control thread of the application software;
receive a request from a client by the socket accept thread;
transfer the request to a data structure;
retrieve the request, by the control thread, from the data structure;
transfer the request to a client thread, by the control thread, to process request data associated with the request; and
process the request data by the client thread.

23. The application of claim 22, wherein the data structure comprises a queue.

24. The application of claim 22, wherein the data structure comprises a FIFO queue.

25. The application of claim 22, wherein the application software is further operable to wait for service requests by calling an accept( ) program.

26. The application of claim 22, wherein the application is further operable to receive the request by receiving a client socket object from the client.

27. The application of claim 22, wherein the application software is further operable to create the client thread to process the request data.

28. The application of claim 22, wherein the application software is further operable to:
receive a second request from the client by the socket accept thread after transferring the request to the data structure;
transfer the second request to the data structure;
retrieve the second request by the control thread;
transfer the second request to a second client thread to process second request data; and
process the second request data by the second client thread.

29. The application of claim 22, wherein the socket accept thread and the control thread are executed on a single processor.

30. The application of claim 22, wherein the application software is further operable to serially perform the steps of transferring the request to the data structure and retrieving the request from the data structure.
